(19) United States
(12) Patent Application Publication
(10) Pub. No.: US 2025/0023348 A1
(43) Pub. Date: Jan. 16, 2025

(54) MULTIFAMILY STRUCTURE ELECTRICAL MANAGEMENT SYSTEM

(71) Applicant: Wojciech Siedlaczek, Burnaby (CA)

(72) Inventor: Wojciech Siedlaczek, Burnaby (CA)

(21) Appl. No.: 18/351,125

(22) Filed: Jul. 12, 2023

(51) Int. Cl. H02J 3/00; H02B 1/26; H02J 13/00

(52) U.S. Cl. CPC H02J 3/0012; H02B 1/26; H02J 13/00002; H02J 13/00004; H02J 13/00022

(57) ABSTRACT

An electrical management system that is configured to measure electrical load demand at a minimum of two points wherein the invention permit, inhibits, or modulates operation of high amperage devices based on the instant load capacity at the main service entrance, sub-feed distribution points, and the multi-family dwelling breaker panel. Included is a first energy management component that is typically installed within a main electrical room. The first energy management component measures the load demand at the main service entrance in the electrical room and includes a communication transceiver or protocol. The transceiver is communicably coupled to a second transceiver wherein the second transceiver is operably coupled to a second energy management component. The second energy management component measures load demand at an individual unit level and communicates with the first energy management component via second transceiver. An electric vehicle charger is operably coupled to the second energy management component.

### FIELD OF THE INVENTION

The present invention relates generally to electrical consumption monitoring, more specifically but not by way of limitation, a system configured to monitor, permit and modulate electrical consumption based on available load wherein the present invention provides monitoring of line current at at least two locations wherein the consumption must be below a threshold to permit and modulate operation of electrical appliances such as but not limited to an electric vehicle charger.

### BACKGROUND

Electric vehicles are becoming more popular and the number of electric vehicle owners has been steadily increasing over the last few years. These vehicles require routine charging of the batteries so as to maintain the capable driving range of the vehicle. The owner of an electric vehicle must equip their residence with the appropriate electrical power in order to accommodate the electric vehicle supply equipment (EVSE) that is utilized to provide charging of the batteries of the electric vehicle. There are several different types of commercially available chargers that are referred to as Level 1, Level 2 and direct current chargers. The aforementioned chargers have different specifications based on the type that include but are not limited to, input voltage, power output and charging speed. By way of example but not limitation, a direct current charger typically requires 100 amp input service and is capable of charging an electric vehicle in under an hour. A typical Level 2 charger will operate on a 220/240V service being equipped with a dedicated 40 amp service breaker.

There is a problem with electrical requirements and code adherence for supplying electric vehicle chargers with the required power in structures such as multifamily dwellings. Electrical requirements for Level 2 chargers placed in multifamily dwellings many times do not meet electrical code requirements as the current required to operate will often exceed the recommended percentage of the available load at the main service entrance or individual unit panels. Specifically, in typical townhouses and row homes, the suite panel, the main electrical service entrance, and possibly other electrical distribution points, need to be monitored to ensure they do not exceed a permitted threshold. Electrical rooms are often separate from the actual multifamily dwelling and therefore running wires between the electrical rooms and each dwelling unit fed from that electrical room is not feasible. Overload scenarios are quite common and controlling private electrical loads such as EV chargers, from common building electrical loading levels cannot be easily achieved with existing technology.

Accordingly, there is a need for an electrical monitoring system that is configured to monitor electrical consumption for at least two locations wherein the system would inhibit or modulate operation of high amperage equipment such as but not limited to electric vehicle chargers if the instant load at any main distribution point (main service, sub-feeders to other distribution, and the multi-family dwelling unit breaker panel) was greater than a programmed percentage.

### SUMMARY OF THE INVENTION

It is the object of the present invention to provide an electric vehicle energy management system configured to provide monitoring of the main service entrance in a multi-family building or complex wherein the present invention includes a first energy management component installed in the main electrical room of a multi-family dwelling building or complex.

Another object of the present invention is to provide an electrical monitoring system for multifamily dwellings wherein the first energy management component includes a transceiver or communication protocol that can transmit data to other components via wired, or wireless methods such as radio, cellular, or Wi-Fi.

A further object of the present invention is to provide an electric vehicle energy management system configured to provide monitoring of electrical loads in a multifamily dwelling that further includes a receiver or communication unit disposed in each of the units of the multifamily dwelling to communicate with the upstream EVEMS components.

Yet a further object of the present invention is to provide an electrical monitoring system for multifamily dwellings wherein each unit of the multifamily dwelling includes a second energy management component to monitor the electrical load of the multifamily dwelling main breaker panel.

Still another object of the present invention is to provide an electric vehicle energy management system configured to provide monitoring of electrical loads in a multifamily dwelling wherein the second energy management component is communicably coupled to the receiver or communication unit.

An additional object of the present invention is to provide an electrical monitoring system for multifamily dwellings wherein the second energy management component is operably coupled to an electric vehicle charger.

Yet a further object of the present invention is to provide an electric vehicle energy management system configured to provide monitoring of electrical loads in a multifamily dwelling wherein the first energy management component and second energy management component measure electric load consumption proximate each location thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an exemplary first energy management component; and

FIG. 2 is a front view of an exemplary receiver unit of the present invention; and

FIG. 3 is an exemplary electrical diagram of a multifamily dwelling with the present invention installed; and

FIG. 4 is an exemplary electrical diagram of a multifamily dwelling with the present invention installed; and

FIG. 5 is an exemplary electrical diagram of a multifamily dwelling with the present invention installed.

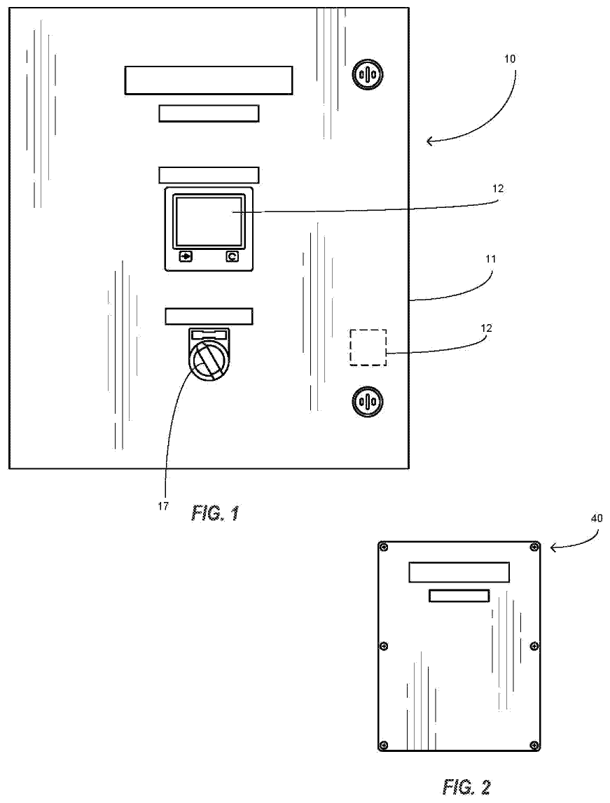

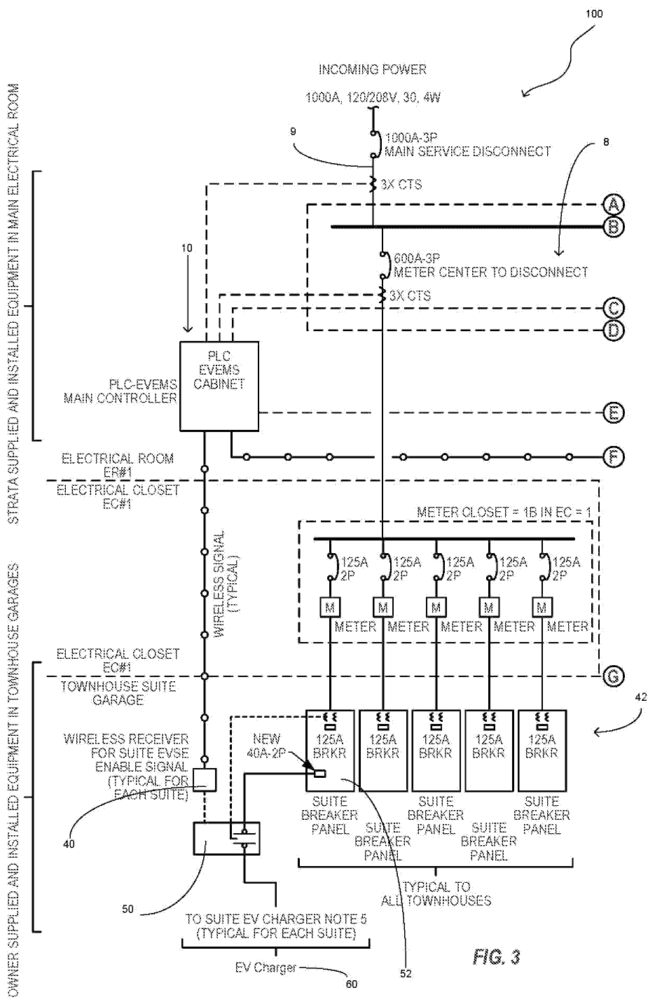

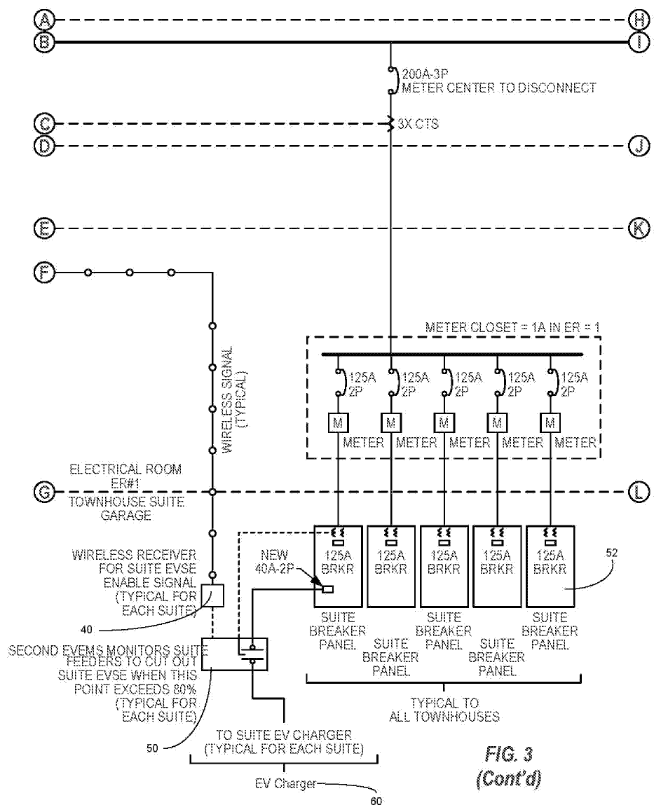

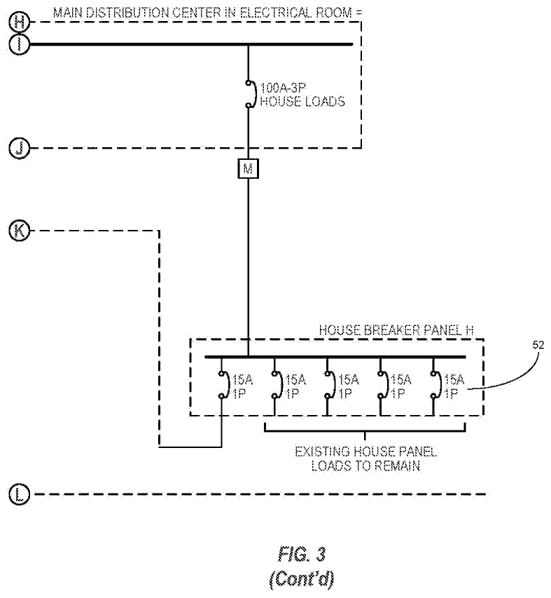

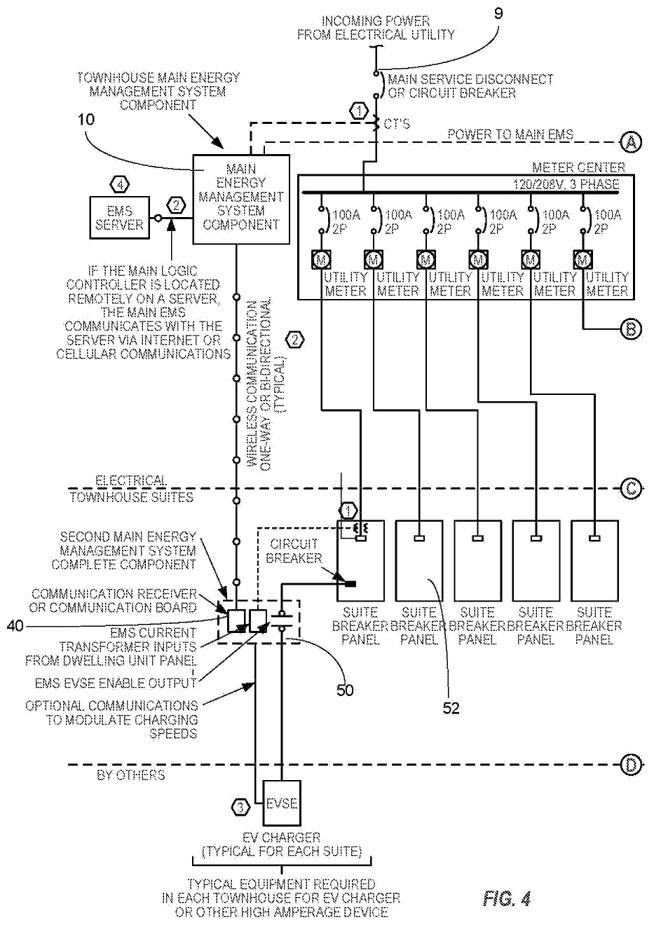

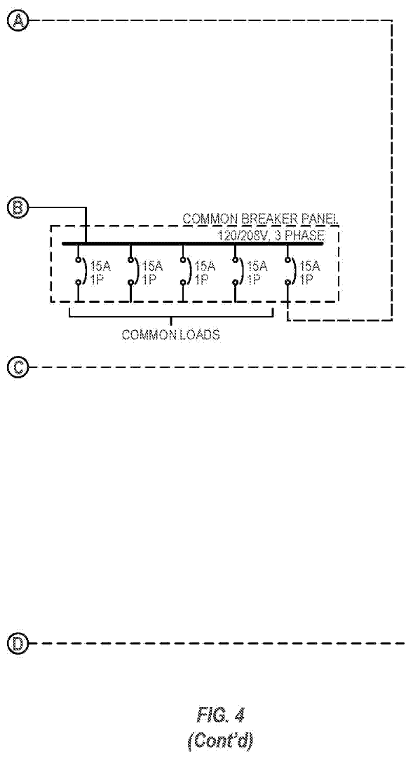

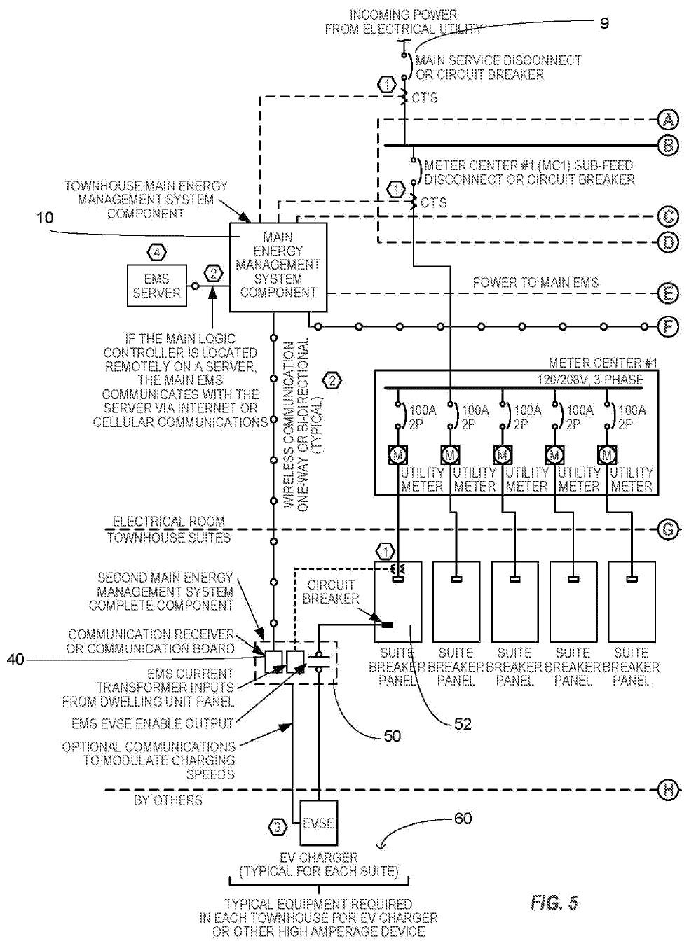

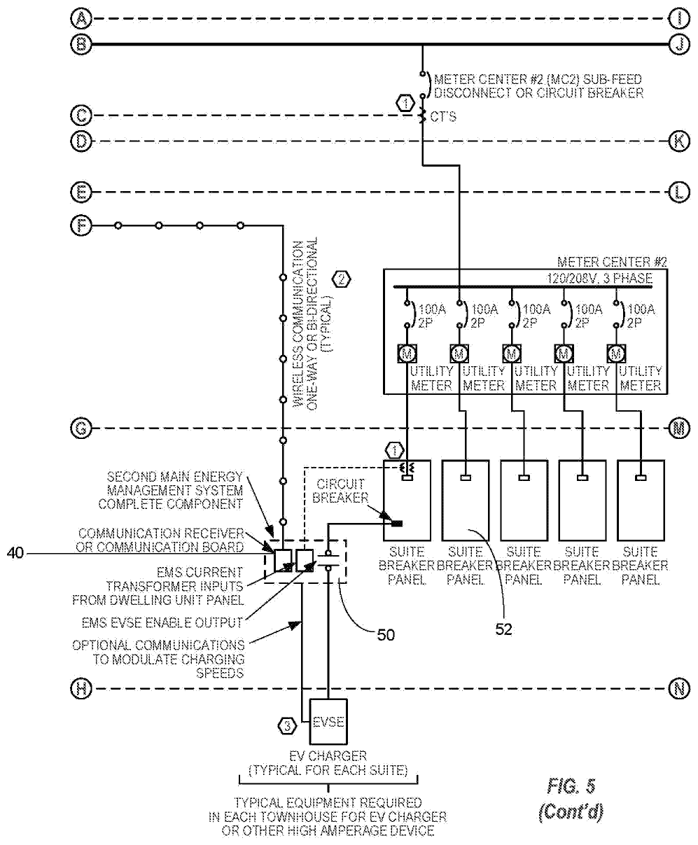

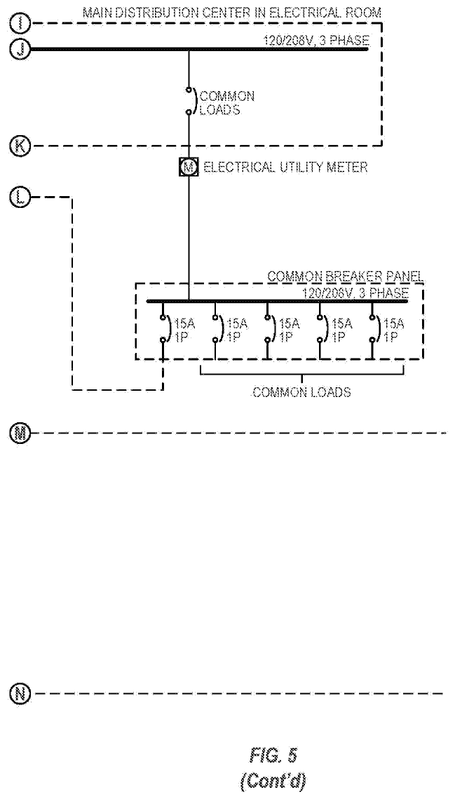

### DETAILED DESCRIPTION

Referring now to the drawings submitted herewith, wherein various elements depicted therein are not necessarily drawn to scale and wherein through the views and figures like elements are referenced with identical reference numerals, there is illustrated an electrical management system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the electrical management system 100 is diagrammed therein. It should be understood that the exemplary townhouse multifamily schematics are for discussion purposes only and that the present invention could be employed in various alternate types of commercial and residential structure. Additionally, it should be further understood within the scope of the present invention that while electric vehicle power management is a preferred embodiment for an application of the present invention that the electrical management system 100 could be deployed to manage electrical load for various other high amperage devices. High amperage device as defined herein is any electrical device that requires twenty or more amperages for operation thereof.

The electrical management system 100 includes a first energy management component 10. The first energy management component 10 is installed in a main electrical room 8 being operably coupled to incoming power supply 9. The first energy management component 10 includes a housing 11 having within the interior volume thereof the necessary electronics and electrical components to operably couple with the incoming power supply 9 and further function as the main controller for the electrical management system 100 with an ability to receive, store, transmit and manipulate data. While the preferred embodiment of the electrical management system 100 provides for mounting of the first energy management component 10 in the main electrical room, it should be understood within the scope of the present invention that the first energy management component 10 could be mounted in alternate locations. The first energy management component 10 further includes an interface screen 12 allowing a user to operably engage therewith. The first energy management component 10 includes a two position switch 17 that places the first energy management component 10 in an on or off position. In the off position the power supply 9 is interrupted and all second energy management components 50 are disabled inhibiting the operation of any electric vehicle chargers 60. It is contemplated within the scope of the present invention that the interface screen 12 could employ a color scheme so as to indicate the status to an operator thereof. By way of example but not limitation, a first color could be employed to indicate the first energy management component 10 is operational but that the second energy management component is not enabled. A second color displayed on the background of the interface screen 12 could be employed to indicate the second energy management component 15 is in an on position. Lastly, a third color could be utilized to indicate the first energy management component 10 is operational but the load demand is exceeding eighty percent and as such not high amperage devices can be activated to an on position.

The first energy management component 10 is programmed to monitor the electrical load demand on the electrical room and determine if sufficient amperage is available to permit devices in the electrical closet 30 having high amperage requirements to operate. In a preferred embodiment of the present invention if the downstream load demand on the main electrical room 8 exceeds eighty percent, the first energy management component 10 will inhibit activation of high amperage devices until the load demand recedes below eighty percent. It should be understood within the scope of the present invention that the first energy management component 10 could be programmed for alternate load demand percentages in place of eighty percent. Furthermore, the first energy management component 10 could also be located on a remote server and communicate with the inputs and outputs in the physical EVEMS panel.

The first energy management component 10 further includes a transceiver 20 installed within the interior volume of the housing 11. The transceiver 20 is configured to transmit and receive wireless data signals. It is contemplated within the scope of the present invention that the transceiver 20 could utilize numerous alternate suitable wireless communication protocols. While wireless communication protocols are in a preferred embodiment, it should be understood within the scope of the present invention that the communication could be radio, cellular, or internet based. The transceiver 20 is communicably coupled to second transceiver 40. The second transceiver 40 is installed in the townhouse suite garage 42. The second transceiver 40 is configured with the necessary electronics to receive, store, transmit and manipulate data. The second transceiver 40 is communicably coupled to transceiver 20 within the first energy management component 10. The second transceiver 40 transmits load information from the second energy management component 50 to transceiver 20 for determination by the first energy management component 10 if a high amperage device can be activated. Additionally, the second transceiver 40 will receive a signal from the transceiver 20 upon load conditions being acceptable to permit activation of the second energy management component 50 to facilitate activation of the high amperage device. As previously stated herein, load demand must be below eighty percent at the main electrical room 8 in order for the transceiver 20 to transmit a signal to the second transceiver 40 with instructions to permit activation of the second energy management component 50.

The second energy management component 50 is electrically coupled to each electrical panel 52 for each townhouse unit. The second energy management component 50 can be electrically coupled to the electrical panel 52 either before or after the main circuit breaker and is operable to measure load demand on the electrical panel 52. The load demand for each electrical panel 52 is transmitted to the first energy management component 10 via second transceiver 40. The electrical management system 100 provides load demand measuring at the main service feed in the electrical room 8 and at each individual electrical panel 52. It should be understood within the scope of the present invention that load demand could be measured at alternate distributions points as required. In a preferred embodiment of the electrical management system 100 the line current is measured at a minimum of two locations providing control of the electric vehicle charger 60 based on the measured instant demand. The programming of the first energy management component 10 utilizes a control sequence to capture all of the electric vehicle chargers 60 load conditions and impose limits on power cycling thereof. It should be understood within the scope of the present invention that the second transceiver 40, second energy management component 50 and electric vehicle charger 60 could be provided as a single unit.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electrical management system operable to operable to inhibit, permit, and modulate operation of high amperage devices wherein the electrical management system comprises:
a first energy management component, said first energy management component being installed in an electrical room for a structure, said first energy management component being electrically coupled to monitor incoming power at a main service entrance, said first energy management component having a housing, said housing having disposed therein electronics configured to receive, store, transmit and manipulate data, said first energy management component having an interface screen, said interface screen providing status information about said first energy management component; a first transceiver, said first transceiver being disposed within said housing of said first energy management component, said first transceiver being configured to transmit and receive signals utilizing wireless communication protocols;
at least one second energy management component, said at least one second energy management component being installed at a second location proximate to a breaker panel within a dwelling unit, said at least one second energy management component being electrically coupled to the breaker panel, said at least one second energy management component configured to receive, store, transmit and manipulate data;
a second transceiver, said second transceiver being operably coupled to said at least one second energy management component, said second transceiver being mounted proximate said at least one second energy management component, said second transceiver communicably coupled with said first transceiver;
at least one high amperage device, wherein the at least one high amperage device is operably coupled to the second energy management device; and
wherein the electrical management system measures the amperage load at least two locations and is programmed with a setpoint to inhibit, permit, or modulate operation of the at least one high amperage device.

2. The electrical management system operable to inhibit, permit, or modulate operation of high amperage devices as recited in claim 1, wherein said setpoint is eighty percent of available amperages provided by the incoming power.

3. The electrical management system operable to inhibit, permit, or modulate operation of high amperage devices as recited in claim 2, wherein said first energy management component inhibits or modulates operation of the at least one second energy management component in an event of amperage load exceeding said setpoint.

4. The electrical management system operable to inhibit, permit, or modulate operation of high amperage devices as recited in claim 3, wherein said first energy management component permits and/or modulates operation of the at least one second energy management component in an event of amperage load being beneath said setpoint.

5. The electrical management system operable to inhibit, permit, or modulate operation of high amperage devices as recited in claim 4, wherein the interface screen employs utilization of three colors to provide visual indication of the status of the electrical management system.

6. The electrical management system operable to inhibit, permit, or modulate operation of high amperage devices as recited in claim 5, and further including an electric vehicle charger, said electric vehicle charger being operably coupled to said second energy management component.

7. The electrical management system operable to inhibit, permit, or modulate operation of high amperage devices as recited in claim 6, wherein said first energy management component includes a switch, said switch configured to enable or disable the electrical management system.

8. The electrical management system operable to inhibit, permit, or modulate operation of high amperage devices as recited in claim 7, wherein the first energy management component measures amperage demand at the main service entrance located between a main service disconnect and electrical meters.

9. The electrical management system operable to inhibit, permit, or modulate operation of high amperage devices as recited in claim 8, wherein the second energy management component measures amperage demand at a breaker panel distal to the electrical room.

10. The electrical management system operable to inhibit, permit, or modulate operation of high amperage devices as recited in claim 9, wherein the second transceiver, second energy management component and electric vehicle charger are contained in a single unit.
